(19) United States
(12) Patent Application Publication
(10) Pub. No.: US 2013/0021829 A1
(43) Pub. Date: Jan. 24, 2013

(54) ARRANGEMENT AND A METHOD FOR SUPPLYING ELECTRIC POWER

(71) Applicant: Charles SAO, Vasteras (SE)

(72) Inventor: Charles SAO, Vasteras (SE)

(21) Appl. No.: 13/553,851

(22) Filed: Jul. 20, 2012

(30) Foreign Application Priority Data
Jul. 22, 2011 (EP) 11175099.8

(51) Int. Cl. H02M 7/44

(52) U.S. Cl. 363/71

(57) ABSTRACT

An arrangement for supplying electric power to a load through a filter bus includes at least two Voltage Source Converters connected in parallel to the filter bus through an inductor each and configured to share the load. Each converter is associated with a control unit configured to regulate the voltage (v_{f}) of the filter bus while maintaining dynamic control of the current from the converter. This control unit involves production of two perpendicularly-intersecting filter bus voltage vectors (v_{fx}, v_{fy}) from the filter bus voltage and the control unit involves production of a current vector (iₖₓ, i_{ky}) for each filter bus vector. The control unit also involves multiplying of each current vector with a droop coefficient common to all the current vectors. The result of this multiplication is sent to means for subtracting this result from the respective filter bus voltage reference vector (v*_{fx}, v*_{fy}).

### TECHNICAL FIELD OF THE INVENTION AND BACKGROUND ART

The present invention relates to an arrangement for supplying electric power to a load through a filter bus, in which the arrangement comprises at least two Voltage Source Converters connected in parallel to said filter bus through an inductor each and configured to share said load, as well as a method for supplying electric power to a load through such an arrangement.

The invention is not restricted to any particular levels of voltage on a said filter bus or powers transferrable to a said load, but 1 kV-32 kV and 100 kW-several MW's, respectively, may be mentioned as examples.

Parallel operation of electric power generators, to which said Voltage Source Converters are connected, is used to share a load connected to said filter bus in common to the converters. One such application is centralized frequency conversion shore to ship power supply, in which said load may be one or several ships connected to said filter bus. An application of such paralleling of converters may also be one or several micro-grids.

There are some advantages of paralleling a plurality of electric power supply units for feeding electric power to said load. One of them is that an increased power rating can be met by using a plurality of lower electric power supply units connected in parallel to a said filter bus instead of using one single high electric power supply unit. This means that maintenance of one such electric power supply unit may be carried out without having to completely shut down the supply of electric power to a said load, since the other electric power supply units may then temporarily take over the part of the load from the unit stopped for maintenance. The redundancy obtained by paralleling several electric power supply units also increases the availability of electric power to a said load, since electric power may be fed thereto as long as a sufficient number of electric power supply units are in operation.

Appended FIG. 1 schematically illustrates a said arrangement having three Voltage Source Converters 1-3 connected in parallel to a filter bus 4 through an inductor 5-7 each to share a common load 8, which in fact may be a plurality of loads, connected to the filter bus. One way to make these converters share the common load is to use a master controller that sets the terminal voltages of all the converters. However, since the electric power generator units to which the converters are connected or belong to may be located quite far apart with significant line impedance between them, parallel operation of the converters should be achieved with no or minimum control communication. An alternative control philosophy that overcomes the dependency of all the converters on a single master controller is to have an individual controller for each converter in the parallel combination.

The use of frequency versus real power and voltage versus reactive power droop schemes for load sharing of independently controlled generators and Voltage Source Converters is well known. However, the converters connected in parallel to a common filter bus through interface inductors and employing such droop schemes operate as voltage sources. Even if they actively regulate the filter bus voltage, they do not have underlying current control loops that regulate and limit their output currents dynamically.

In order to achieve dynamic current control and current limiting capability each converter in FIG. 1 must employ a voltage vector control, e.g. a d-q frame or α-β frame voltage control, with an underlying current controller. This is to regulate the filter bus voltage vector while maintaining dynamic control of the converter current. An example of a control unit obtaining this for one said converter is shown in appended FIG. 2. This control unit 10′ comprises first means 11′ (indicated by signal arrows), configured to produce two perpendicularly-intersecting filter bus voltage vectors v_{fx}, v_{fy} from the filter bus voltage v_{f}, second means 12′ (indicated by signal arrows) configured to produce a filter bus voltage reference vector v*_{fx}, v*_{fy}, for each of said two filter bus voltage vectors, third means 13′ configured to sum each said filter bus voltage vector and the filter bus voltage reference vector associated therewith, a regulator 14′ connected to receive the result of the summing of said third means so as to produce a current reference vector for each filter bus voltage vector, and fourth means 15′ configured to involve current control in the control of the converter based on said current reference vectors for obtaining two vectors (iₖₓ, i_{ky}) of the current from the k^{th} converter perpendicularly-intersecting each other. With this control scheme the converters can be modeled as current sources 16-18 that are connected directly to the filter bus 4 as shown in appended FIG. 3. These current sources adjust their output currents within current limits to regulate the filter bus voltage. However, the control scheme of FIG. 2 would work if only one of the converters in FIG. 1 is in operation at a time. If multiple converters are switched on, the controllers of said fourth means would fight with one another because they are all attempting to regulate the same voltage vector of the filter bus. Moreover, there is nothing in FIG. 2 that guarantees that they will share a common load. The well known frequency versus real power and voltage versus reactive power droop schemes cannot be used to make these current sources share a common load because these droop schemes are strictly for voltage sources connected in parallel through inductances.

U.S. Pat. No. 7,567,064 discloses an arrangement for supplying electric power of the type defined in the introduction with independent control of each converter.

### SUMMARY OF THE INVENTION

The object of the present invention is to provide an arrangement and a method of the type disclosed above advising an advantageous alternative way of obtaining independent control of each converter of a plurality of voltage source converters connected in parallel to a filter bus through an inductor each and sharing a common load.

This object is according to the invention obtained by providing an arrangement according to the preamble of appended claim 1 with the further feature that said control unit for each converter also comprises fifth means configured to multiply each current vector or current reference vector with a droop coefficient cornmon to all current vectors or current reference vectors and send the result of this multiplication to said third means for subtracting this result from the respective filter bus voltage reference vector.

Drooping the voltage reference vector components ensures that the control units will not fight with one another when controlling the respective converter and the converters may share a common real and reactive load while being independently controlled.

According to an embodiment of the invention each said control unit for the respective said converter further comprises sixth means configured to receive an unlimited current reference vector for each said filter bus voltage vector from said regulator and to limit the magnitude of each said unlimited current reference vector and send a limited current reference vector to said fourth means. This means that the magnitude of each current reference vector may be limited to not exceed a level that damages the converter.

According to another embodiment of the invention each said control unit for the respective converter further comprises seventh means configured to send a feed-forward signal representing the load current to eighth means configured to sum an output signal from said regulator so as to produce said current reference vector for each said filter bus voltage vector. Such a use of a load current feed-forward signal enhances the speed of response of the current control in the control of the respective converter during load changes.

According to other embodiments of the invention each said first means is configured to produce said filter bus voltage vectors according to the d-q frame or the α-β frame, and each said fourth means include a d-q current controller and an α-β current controller, respectively.

According to another embodiment of the invention the arrangement comprises a filter arranged between said first means and said third means for smoothing out said filter bus voltage vectors before reaching said third means.

A method for supplying electric power to a load through a filter bus by means of at least two Voltage Source Converters connected in parallel to said filter bus through an inductor each and configured to share said load enabling independent control of said converters is according to the invention defined in the appended independent method claim. Advantages and advantageous features of such a method and of the embodiments thereof defined in the dependent method claims appear clearly from the above discussion of the arrangement according to the present invention.

The invention also relates to a computer program product and a computer readable medium associated with a method according to the present invention.

Further advantages as well as advantageous features of the invention will appear from the following description.

### BRIEF DESCRIPTION OF THE DRAWINGS

With reference to the appended drawings, below follows a specific description of an embodiment of the invention cited as an example.

In the drawings:

FIG. 1 is a very schematic view of an arrangement of the type to which the invention belongs,

FIG. 2 is a schematic simplified view of a possible control unit for an arrangement according to FIG. 1 requiring a single master controller for controlling the converters in dependence of each other,

FIG. 3 is a schematic view of the arrangement according to

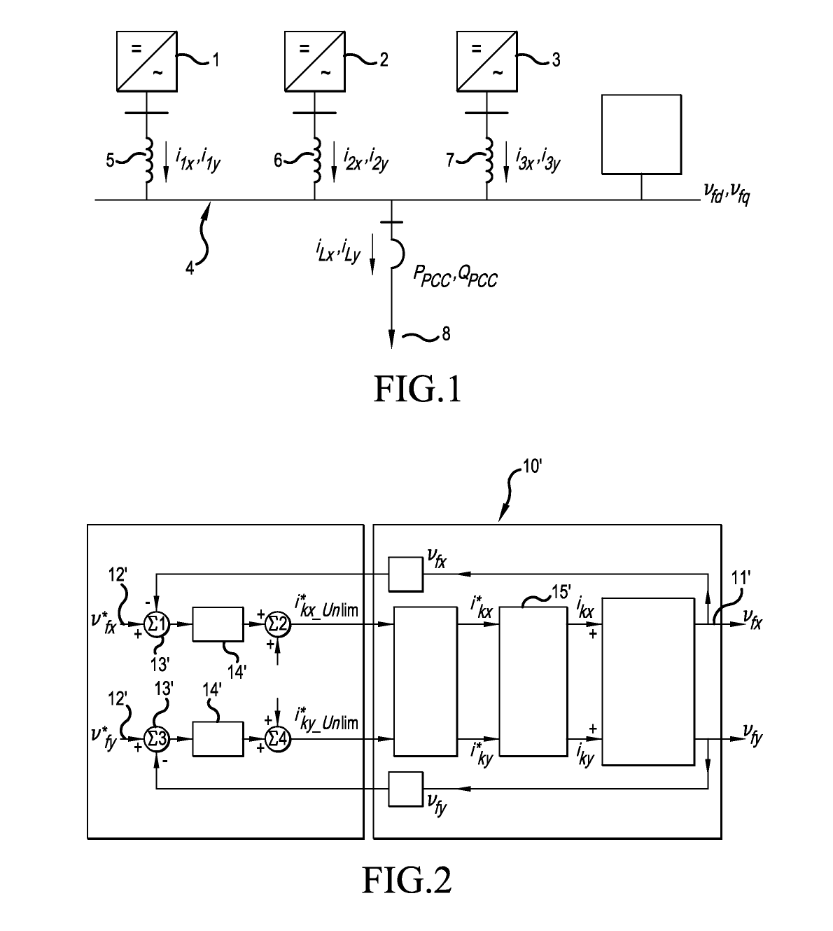

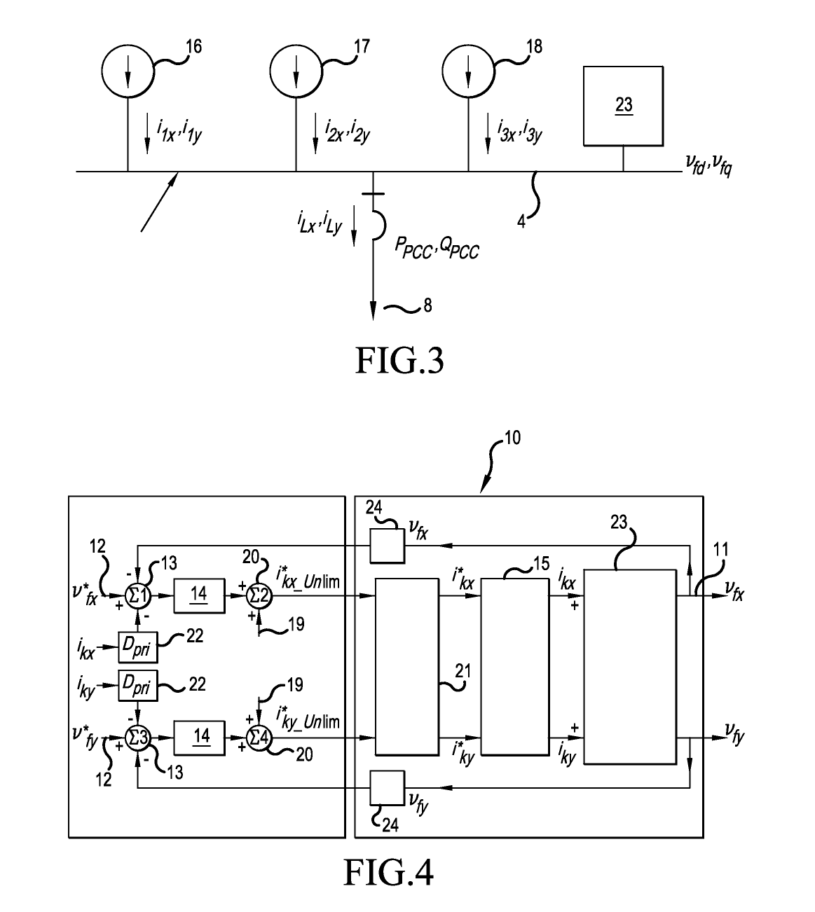

FIG. 1 illustrating the control aimed at through control units according to FIG. 2, and

FIG. 4 is a view of a control unit in an arrangement according to the present invention having an individual controller for each converter connected in parallel.

### DETAILED DESCRIPTION OF AN EMBODIMENT OF THE INVENTION

An arrangement according to an embodiment of the invention for supplying electric power to a load of the type shown in FIG. 1 has for each converter thereof a control unit 10 shown in FIG. 4 configured to regulate the voltage of the filter bus while maintaining dynamic control of the current from the converter. Each such control unit comprises first means 11 configured to produce two perpendicular-intersecting filter bus voltage vectors v_{fx} and v_{fy} from the filter bus voltage v_{f}. The first means may be configured to produce said filter bus voltage vectors according to the d-q frame or α-β frame. The control unit also comprises second means 12 configured to produce a filter bus voltage reference vector v*_{fx}, v*_{fy}, for each of said two filter bus voltage vectors.

These filter bus voltage reference vectors may be set by an operator, which is then comprised in said second means, if the arrangement has one group of converters or higher level controls if the arrangement comprises several converter groups. The arrangement also comprises third means 13 configured to sum each said filter bus voltage vector v_{fx}, v_{fy} and the filter bus voltage reference vector v*_{fx}, v*_{fy}, associated therewith. The control unit also comprises, for each of the two perpendicularly-intersecting vectors, a regulator 14 connected to receive the result of the summing of said third means to ensure that the filter bus voltage vector tracks its reference without any steady state error in principle.

Furthermore, the control unit comprises seventh means 19 configured to send a feed-forward signal representing the load current to eighth means 20 configured to sum an output signal from the regulator so as to produce an unlimited current reference vector i*_{kx-Unlim}, i*_{ky-Unlim}. This use of a load current feed-forward signal enhances the speed of response of the controller of the control unit controlling the converter during load changes. It may also be used to cancel the effect of coupling between said perpendicularly-intersecting vectors of the arrangement.

The control unit also comprises six means 21 in the form of a current limiter block configured to receive said unlimited current reference vector for each said filter bus voltage vector from the means 20 and to limit the magnitude of said unlimited current reference vector and send a limited current reference vector i*ₖₓ, i*_{ky} to fourth means 15 configured to involve current control in the control of the converter based on said current reference vectors for obtaining two vectors iₖₓ, i_{ky} of the current from said converter perpendicularly-intersecting each other.

It is shown in FIG. 4 how the control unit also comprises fifths means 22 configured to multiply each current vector iₖₓ, i_{ky} of the k^{th} converter with a common droop coefficient Dₚᵣᵢ and send the result of this multiplication to said third summing means 13 for subtracting this result from the respective filter bus voltage reference vector. In other words, the voltage reference vector for the k^{th} converter is drooped against the components of the current vector of that converter.

Assuming no limiter action, the inputs of the regulators in FIG. 4 must be zero in steady state. Thus, the steady state converter current vector components are given by

$$\begin{matrix}{i}_{kx} = \frac{{v}_{fx \_ k}^{*} - {v}_{fx}}{{D}_{pri \_ k}} & ( 1 ) \\ {i}_{ky} = \frac{{v}_{fy \_ k}^{*} - {v}_{fy}}{{D}_{pri \_ k}} & ( 2 )\end{matrix}$$

In a converter bank as shown in FIG. 1, the filter bus voltage will be common to all the converters. Provided that all the converters have identical voltage vector component droop coefficients and voltage reference vectors, (1) and (2) imply that the rectangular components (perpendicularly-intersecting vectors) of the output current vector of the k^{th} converter is equal to the corresponding components of the output current vectors of all the other converters in the same converter group. Thus, the converters share a common real and reactive load. Drooping the voltage reference vector components also ensures that the converter controllers included in said fourth means 15 do not fight with one another. Accordingly, the droop scheme shown in FIG. 4 allows parallel operating converters, such as the ones shown in FIG. 1, to jointly regulate the filter bus voltage vector while sharing a common load.

In addition to the above description of the control unit 10 shown in FIG. 4 it may be mentioned that said fourth means 15 besides a d-q or α-β controller will include a PWM (Pulse Width Modulation) switching generator, a converter bridge and interface inductors, and the block 23 represents filter bus dynamics. It is also shown how a filter 24 is arranged between the first means 11 and the third means 13 for smoothing out the filter bus voltage vectors before reaching the third means. Besides the load current feed-forward branch there is also a voltage vector feed-forward branch not shown feeding forward a function of vq to the vd control path and a function of vd to the vq control path for decoupling d and q axis dynamics.

The invention is of course not in any way restricted to the embodiment described above, but many possibilities to modifications thereof would be apparent to a person with ordinary skill in the art without departing from the scope of the invention as defined in the appended claims.

The limited current reference vectors i*ₖₓ, i*_{ky} of the k^{th} converter may be multiplied with a common droop coefficient instead of the current reference vectors iₖₓ, i_{ky} if the current controller included in said fourth means is slow.

1. An arrangement for supplying electric power to a load through a filter bus, the arrangement comprising
at least two Voltage Source Converters connected in parallel to said filter bus through an inductor each and configured to share said load, and
for each said converter, a control unit configured to regulate the voltage of the filter bus while maintaining dynamic control of the current from the converter, each said control unit comprising
a) first means configured to produce two perpendicularly-intersecting filter bus voltage vectors (v_{fx}, v_{fy}) from said filter bus voltage (v_{f}),
b) second means configured to produce a filter bus voltage reference vector (v*_{fx}, v*_{fy}) for each of said two filter bus voltage vectors,
c) third means configured to sum each said filter bus voltage vector (v_{fx}, v_{fy}) and the filter bus voltage reference vector (v*_{fx}, v*_{fy}) associated therewith,
d) a regulator connected to receive the result of the summing of said third means so as to produce a current reference vector (i*_{kx-Unlim}, i*_{ky-Unlim}) for each said filter bus voltage vector (v_{fx}, v_{fy}), and
e) fourth means configured to involve current control in the control of said converter based on said current reference vectors for obtaining two vectors (iₖₓ, i_{ky}) of the current from said converter perpendicularly-intersecting each other,
wherein said control unit also comprises fifth means configured to multiply each said current vector (iₖₓ, i_{ky}) or current reference vector (i*_{kx-Unlim}, i*_{kx-Unlim}, i*ₖₓ, i*_{ky}) with a droop coefficient (Dₚᵣᵢ) common to all said current vectors or current reference vectors and send the result of this multiplication to said third means for subtracting this result from the respective filter bus voltage reference vector (v*_{fx}, v*_{fy}).

2. An arrangement according to claim 1, wherein each said control unit for the respective said converter further comprises sixth means configured to receive an unlimited current reference vector (i*_{kx-Unlim}, i*_{ky-Unlim}) for each said filter bus voltage vector from said regulator and to limit the magnitude of each said unlimited current reference vector and send a limited current reference vector (i*ₖₓ, i*_{ky}) to said fourth means.

3. An arrangement according to claim 1, wherein each said control unit for the respective converter further comprises seventh means configured to send a feed-forward signal representing the load current to eighth means configured to sum an output signal from said regulator so as to produce said current reference vector for each said filter bus voltage vector (v_{fx}, v_{fy}).

4. An arrangement according to claim 1, wherein each said first means is configured to produce said filter bus voltage vectors according to the d-q frame, and that each said fourth means include a d-q current controller.

5. An arrangement according to claim 1, wherein each said first means is configured to produce said filter bus voltage vectors according to the α-β frame, and that each said fourth means include an α-β current controller.

6. An arrangement according to claim 1, wherein it comprises a filter arranged between said first means and said third means for smoothing out said filter bus voltage vectors before reaching said third means.

7. A method for supplying electric power to a load through a filter bus by means of at least two Voltage Source Converters connected in parallel to said filter bus through an inductor each and configured to share said load, in which the voltage of the filter bus is regulated while maintaining dynamic control of the current from each converter, said method comprises the following steps carried out for each converter:
1) producing two perpendicularly-intersecting filter bus voltage vectors (v_{fx}, v_{fy}) from said filter bus voltage (v_{f}),
2) producing a filter bus voltage reference vector (v*_{fx}, v*_{fy}) for each of said two filter bus voltage vectors,
3) summing each said filter bus voltage vector (v_{fx}, v_{fy}) and the filter bus voltage reference vector (v*_{fx}, v*_{fy}) associated therewith,
4) processing the result of said summing while producing a current reference vector (i*_{kx-Unlim}, i*_{ky-Unlim}) for each said filter bus voltage vector (v_{fx}, v_{fy}), and
5) controlling each said converter while involving current control based on said current reference vector for obtaining two vectors (iₖₓ, i_{ky}) of the current from each converter perpendicularly-intersecting each other,
wherein it comprises a further step 6) of multiplying each said current vector (iₖₓ, i_{ky}) or current reference vector (i*_{kx-Unlim}, i*_{kx-Unlim}, i*ₖₓ, i*_{ky}) with a droop coefficient (Dₚᵣᵢ) common to all said current vectors or current reference vectors, and that in step 3) the result of this multiplication is subtracted from the respective filter bus voltage reference vector (v*_{fx}, v*_{fy}).

8. The method according to claim 7, wherein in step 4) an unlimited current reference vector (i*_{kx-Unlim}, i*_{ky-Unlim}) is first produced for each said filter bus voltage vector and the magnitude of each said unlimited current reference vector is then limited.

9. A method according to claim 7, wherein it comprises a further step 7) of obtaining a feed-forward signal representing the load current, and that in step 4) said feed-forward signal is used for producing said current reference vector for each said filter bus voltage vector.

10. A method according to claim 7, wherein in step 1) said two perpendicularly-intersecting filter bus voltage vectors are produced according to the d-q frame, and that in step 5) said current control is a d-q current control.

11. A method according to claim 7, wherein in step 1) said two perpendicularly-intersecting filter bus voltage vectors are produced according to the α-β frame, and that in step 5) said current control is a α-β current control.

12. A computer program product storable on a computer usable medium containing instructions for a processor to evaluate the method according to claim 7.

13. A computer program product according to claim 12 provided at least partially through a network, such as the Internet.

14. A computer readable medium, wherein it contains a computer program product according to claim 12.

15. A method of use of an arrangement according to claim 1 for supplying electric power from at least two Voltage Source Converters on shore to one or several ships connected to said filter bus.

16. A method of use of an arrangement according to claim 1 for supplying electric power from at least two Voltage Source Converters to one or several micro-grids connected to said filter bus.

17. An arrangement according to claim 2, wherein each said control unit for the respective converter further comprises seventh means configured to send a feed-forward signal representing the load current to eighth means configured to sum an output signal from said regulator so as to produce said current reference vector for each said filter bus voltage vector (v_{fx}, v_{fy}).

18. An arrangement according to claim 2, wherein each said first means is configured to produce said filter bus voltage vectors according to the d-q frame, and that each said fourth means include a d-q current controller.

19. An arrangement according to claim 3, wherein each said first means is configured to produce said filter bus voltage vectors according to the d-q frame, and that each said fourth means include a d-q current controller.

20. An arrangement according to claim 2, wherein each said first means is configured to produce said filter bus voltage vectors according to the α-β frame, and that each said fourth means include an α-β current controller.
